(19) United States
(12) Patent Application Publication
(10) Pub. No.: US 2025/0360044 A1
(43) Pub. Date: Nov. 27, 2025

(54) EMO-AI

(71) Applicants: Saeid Sanei, London (GB); Amin Safaei, Nottingham (GB)

(72) Inventors: Saeid Sanei, London (GB); Amin Safaei, Nottingham (GB)

(21) Appl. No.: 18/674,841

(22) Filed: May 25, 2024

(51) Int. Cl. A61H 19/00; A61H 23/00; A61H 23/02

(52) U.S. Cl. CPC A61H 19/00; A61H 23/006; A61H 23/02; A61H 2201/1207; A61H 2201/501; A61H 2201/5058; A61H 2201/5097; A61H 2230/105

(57) ABSTRACT

A system is disclosed including a headset with one single multi-pin dry electrode and an earlobe electrode recording EEG, a signal processing unit including lowpass filter, battery, amplifier, A/D convertor, and Bluetooth transmitter. The system further includes a signal processing software on a smart phone, wirelessly receiving and processing the EEG readings and estimating a user's sexual wanting emotion, sensed from the user's scalp Cz zone; replacing eye-blink peak anomalies with prediction of EEG signal samples; generating continuous command signals, wirelessly transmitting the signals, converting signals to analogue signals, applying signals to a DC motor coupled to a haptic caressing body stimulator, actuating vibration, circular and/or thrusting movement to control the stimulator by following the level of the brain wanting state based on real-time prediction of user's next level of sexual wanting emotion, in the absence of any feedback and solely based on the user's brain wave (EEG) reading.

### TECHNICAL FIELD

This application relates generally to the field of Electroencephalography (EEG) studies of human brain electrical signals identifying a person's emotions and brain activity. More specifically, this application relates to a measuring of “wanting” state of the brain signals with application to generation of a stimulator driver command signal as an indication of demand for pleasure.

Noninvasive EEG signals recorded using scalp-mounted electrodes include the underlying information about brain activity representing brain states (such as awake and sleep) emotions (such as happiness and sadness), motor functions related to various body movements, and various diseases, abnormalities (such as autism, depression, and Alzheimer's), and the brain responses to audio, video, and haptic stimulations (as used in brain computer interfacing and further for physical and mental rehabilitation). The related information can be estimated using various data processing methods. Such methods are often used for multichannel EEG.

The present disclosure system is meant to best capture the “wanting” state of the brain, as one of the two components of emotion source. Moreover, this important information is captured by only a single channel EEG device and the necessary signal processing and machine learning techniques have been developed for this challenging single-channel scenario. These include denoising, processing, and driving the necessary control signal. For this purpose, the disclosure system is equipped with an intelligent real-time eye-blink removal from single channel EEG signals and another intelligent and adaptive system to predict the future levels of the motor driver control signal from the current and previous estimates of the signal dynamics. The signal dynamics are estimated using an adaptive multiscale dispersion entropy algorithm and the rate of entropy changes, which is then smoothed to suit for motor control.

### BRIEF DESCRIPTION OF THE DRAWINGS

The drawings, when considered in connection with the following description, are presented for the purpose of facilitating an understanding of the subject matter sought to be protected.

FIG. 1 shows an example of the overall block diagram of elements and process steps involved in the Emo-AI system;

FIG. 2A shows an example of human brain lateral view configuration identifying the frontal scalp region proximities for EEG electrode setting positions;

FIG. 2B shows an example of human brain top view configuration identifying frontal region proximities for EEG electrode setting positions;

FIG. 3 shows an example of a sample of the processor output signal which is (inverted and) transmitted in real-time to a haptic driver.

FIG. 4 shows an example of a lateral view of a human brain identifying areas responsible for, and the path of, signals specific to “wanting” and “liking”;

FIG. 5 shows an example of a diagram showcasing the relative effects of wanting versus liking over time;

FIGS. 6A and 6B show two examples of a user brain wave EEG reading with eye-blink and after eye-blink removed through processing and prediction; and

FIG. 7 shows an example of a flow diagram providing a general outline of steps included in an algorithm used to process EEG brain signals to actuate a haptic caressing stimulator.

### SUMMARY

While the present disclosure is described with reference to several illustrative embodiments and example devices described herein, it should be clear that the present disclosure should not be limited to such embodiments. Therefore, the description of the embodiments provided herein is illustrative of the present disclosure and should not limit the scope of the disclosure as claimed. In addition, while following description references use of EEG electrodes to measure brain signals' electrical voltage amplitude, it will be appreciated that the disclosure may be applicable to other types of brain or bodily reflected signals analyzed and processed to exploit the sexual wanting state of the brain detected by the proposed system to enhance the pleasure and the convenience in achieving that by actuating a brain-controlled haptic caressing stimulator.

Briefly described, a system and a method are disclosed including an EEG headset, where the headset includes a single channel EEG electrode, an earlobe electrode, and a battery powered wireless transmitter. The system further includes an electronic pre-processor, and a processor which could be part of an embedded software using the processor of a smart phone, or a standalone electronic circuitry including a microcontroller. Processing of a series of measured brain signals sensed and transmitted by the EEG headset on an ongoing basis yields a real-time new brain state prediction providing data, as a measure of wanting level in the brain. This measure is smoothed, normalized, and the slope estimated. After each 2-sec analysis, the new state/slope is predicted. The processed brain state prediction is used as a basis for generating a real-time command signal actuating a haptic caressing stimulator in touch with a user erogenous body part sensitive to sexual stimulation, further inducing and enhancing a pleasure wanting sense in the user brain. Along the continuous measurement, the predicted segment is replaced with the new measurement, so the next prediction becomes more accurate.

In various embodiments, the disclosed system includes a headset, including a single channel EEG electrode, an earlobe electrode, and a battery powered wireless transmitter. The system further includes an electronic circuitry comprising a lowpass filter, a signal differential amplifier, and a processor. The system further includes a haptic caressing sexual stimulator.

In various embodiments, the disclosed method details a user coupling single channel EEG electrode headset to her head, mounting the single EEG electrode on midline central region of their scalp, coupling an earlobe electrode to one of her earlobes, effectuating a sensed EEG signal representing the user sexual wanting emotion to be transmitted wirelessly to a smartphone or a microcontroller. An embedded software is developed for processing the signal into a noise free, amplified, and normalized signal. The processed signal is used to estimate the level of wanting state and predict the upcoming brain state, which is replaced by the new estimate in the next step. Both, the estimated trend, and its slope are then used to generate the command signal, actuating a haptic caressing sexual stimulator in touch with the user erogenous body part sensitive to sexual stimulation, further inducing and enhancing a pleasure wanting sense in the user brain.

In various embodiments, an artificial intelligence system captures a series of real-time sensed EEG signals, which contain the information about the user sexual emotion, processes the signals into a noise free, filtered, normalized set of data representing the user sexual wanting, predicting a new brain state, generating a command signal, actuating a haptic caressing sexual stimulator in touch with the user erogenous body part sensitive to sexual stimulation, further inducing and enhancing a pleasure wanting sense in the user brain.

EEG technology records the information about activities inside a person's brain by recording signals produced by aggregation of the signals from firing of individual brain neurons and propagated in the brain through inhibitory and excitatory channels. Upon a neuron receiving enough excitatory signals from the person's nerve system transmitting signals from body sensory cells and other neurons, the neuron generates a response called an action potential, causing the neuron to release chemicals exciting all the cells connected to a part of the firing neuron called the axon. During this process, there is a rapid exchange of ions in the form of electrically charged particles that changes a voltage of the fluid surrounding the firing neuron in a predictable fashion. This voltage change is propagated from the firing neuron towards the surface of the cortex, skull, and eventually scalp. Upon the voltage change (highly attenuated by the skull) reaching the scalp, using electrodes attached to the scalp, EEG measures the brain activity by measuring voltages at different scalp locations over time. The EEG readings represent variation in voltage reading in response to the firing of many neurons simultaneously. The EEG signals have an effective bandwidth of approximately 50 Hz and therefore, a sampling frequency of more than 100 Hz can be used for its analogue (continuous) reconstruction and processing. Temporal, spectral, and statistical information and parameters are often estimated and used to describe single channel EEG signals. Many other adaptive or non-adaptive techniques can be used or developed for processing multichannel EEG signals. Example of EEG wave types are presented by Stern in “Atlas of EEG Patterns' (Wolters Kluwer, 2013). These wave types are generally divided into delta, theta, alpha, beta, and gamma waves, with each type representing a specific range of frequencies. There is also mu rhythm elicited due to brain motor activity, k-complex and spindles during sleep, and sharp waves due to seizure, hypertension, brain tumour, or certain mental diseases. Some systems further subdivide these wave types into Subcategories, such as alpha1, alpha2, etc. Research has shown that different EEG wave types correlate with activity in different regions of the brain, representing various internal mental states, for example particular emotions and thoughts, phases of sleep, and medically relevant neurological activity (e.g. seizures), and other causes generating an EEG detected brain wave. There are also waves generated due to eye movement, eye blink, and as mentioned before due to movement.

However, not all descriptors of brain activity stem from frequency-domain analysis. For example, audio, visual, or haptic stimulation leads to generation of event related potentials within 0-400 msec after the stimulation. These responses can significantly change due to mental abnormalities such as autism, mild cognitive impairment, Alzheimer's, and depression. Therefore, their assessment can provide physiological biomarkers for such abnormalities (Sanei et al., EEG Signal Processing and Machine Learning, Wiley 2021).

There are also works trying to estimate the brain state for mental abnormalities such as mild cognitive impairment and Alzheimer's by estimating the connectivity between various brain regions and use that as the biomarker to identify the severity of the disease (Sanei et al., EEG Signal Processing and Machine Learning, Wiley 2021).

On the other hand, synchronization, or chaos in the brain, representing the changes in the brain dynamics, occurs in many cases. For example, just before any intentional movement the brain waveforms become more synchronized and go back to desynchronization immediately after the movement. In another example, before any seizure onset, the brain waves tend to be more synchronized (Sanei et al., EEG Signal Processing and Machine Learning, Wiley 2021). However, estimation of chaos (also known as entropy) in EEG signals arising due to wanting component of emotion, is our finding which is considered here and a new and effective approach is followed to estimate it accurately. This property of the EEG signals, in relation to emotion, particularly wanting state of the brain, is central to present disclosure.

### DETAILED DESCRIPTION

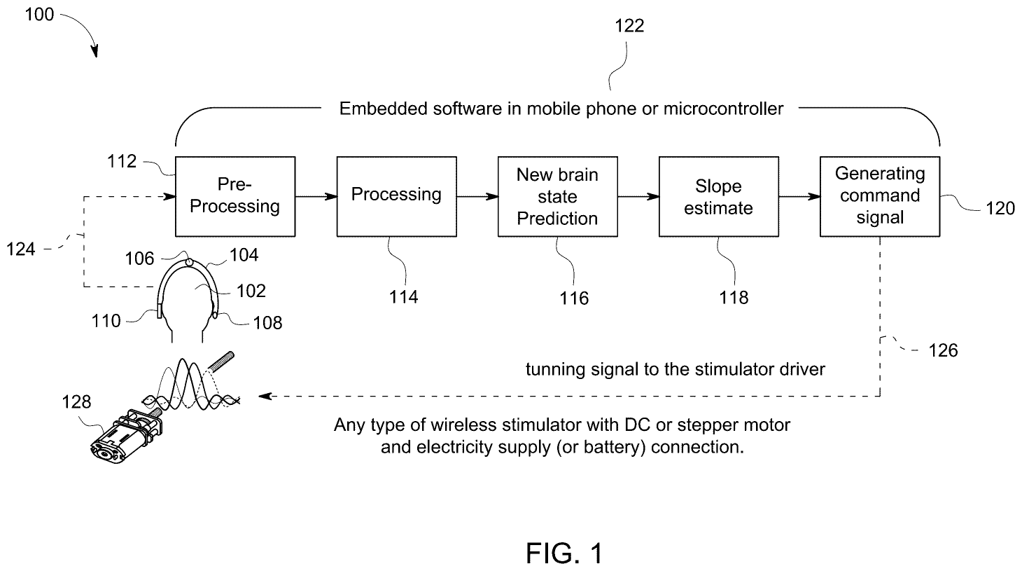

Present disclosure describes Emo-AI (Emotion Artificial Intelligence), which is an emotion-driven stimulator, using brain waves. Emo-AI is a real-time hand-free body stimulator controlled by reading the human mind and deciding about the stimulation intensity. Emo-AI uses the signal continuously recorded from the brain using a non-invasive and minimally intrusive single channel wireless wearable EEG system. It uses a metric which is an estimation of the changes in dynamic (chaos, entropy, or fluctuation) in the brain, which is gradually intensified or diminished based on human desire. The person's demands for stronger stimulation (which can continue till fully satisfied) or less stimulation, for example after reaching to their climax, is predicted, and acted upon. This system is fully informed and controlled by human emotion (and not by any physical or imaginary movement). The system demonstrated in FIG. 1 represents an overall block diagram of the Emo-AI system.

To use the system, the person (male or female) wears the EEG headset and fits the stimulator in a comfortable situation and turns both headset and stimulator on.

In general, for remote capturing EEG signals an option could be using a wireless multichannel EEG system. However, these options are not useable for the purpose of present disclosure as they are intrusive, difficult, and take long time to setup. There are also few single channel EEG systems (such as NeuroSky) in the market, usually used for computer gaming with one flat electrode appliable to forehead. Such electrodes cannot capture the activity from the vicinity of mid-central scalp area, which is often covered by hair.

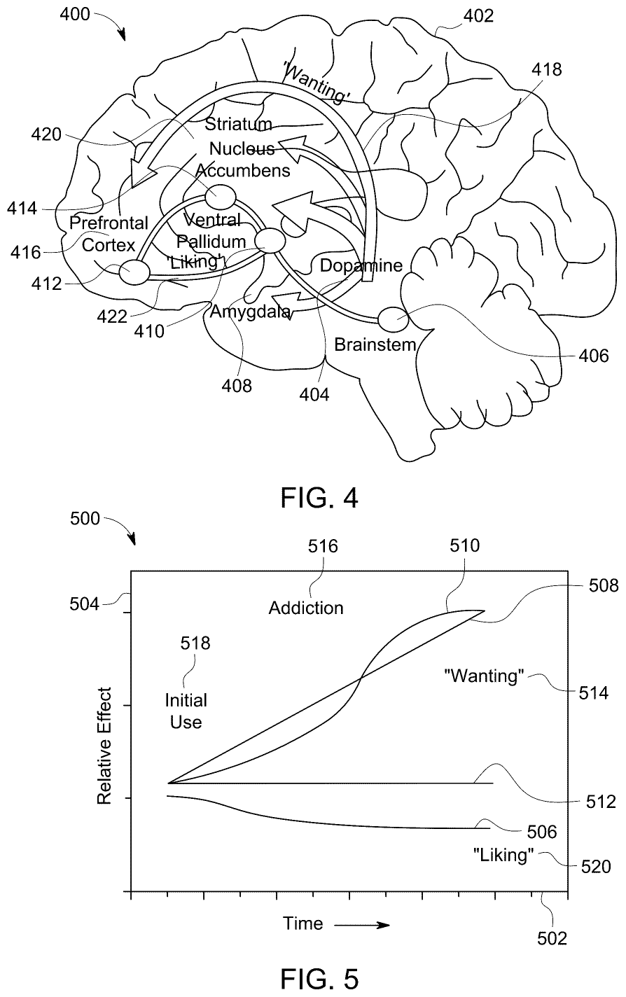

As a basis for identifying a preferred location of scalp to couple the EEG electrode, it should be noted that the source of emotions is in amygdale (amygdala) under the two brain lobes, which is not accessible by surface scalp electrodes. Referring to FIG. 4, these signals have two components; one is to do with “liking,” and the other “wanting,” where wanting is more related to strong vying emotions such as sexual. Liking is a fixed feeling and of no use to our design. On the other hand, wanting is an evolving brain function and is of our interest. The “wanting” signal propagates to the cortex surface from occipital to frontal regions and has maximum amplitude around Fz (frontal central) area. However, at this location the “wanting” signal is corrupted with strong signals such as transient beta rebound (due to start of a body movement), de-synchronization/synchronization (due to movement intention), beta waves due to attention, eye-blink, and eye-movement artifacts. Beta waves are high-frequency, low-amplitude brain waves that are commonly observed in an awaken state. Beta waves are involved in conscious thought and logical thinking. There is also debate that neurodevelopmental diseases may affect the brain rhythms in this area. So, the best place is around Cz (mid-central position, right on top of the head,) which has a second strongest reception of “wanting” signal and is less affected by the above identified interferences.

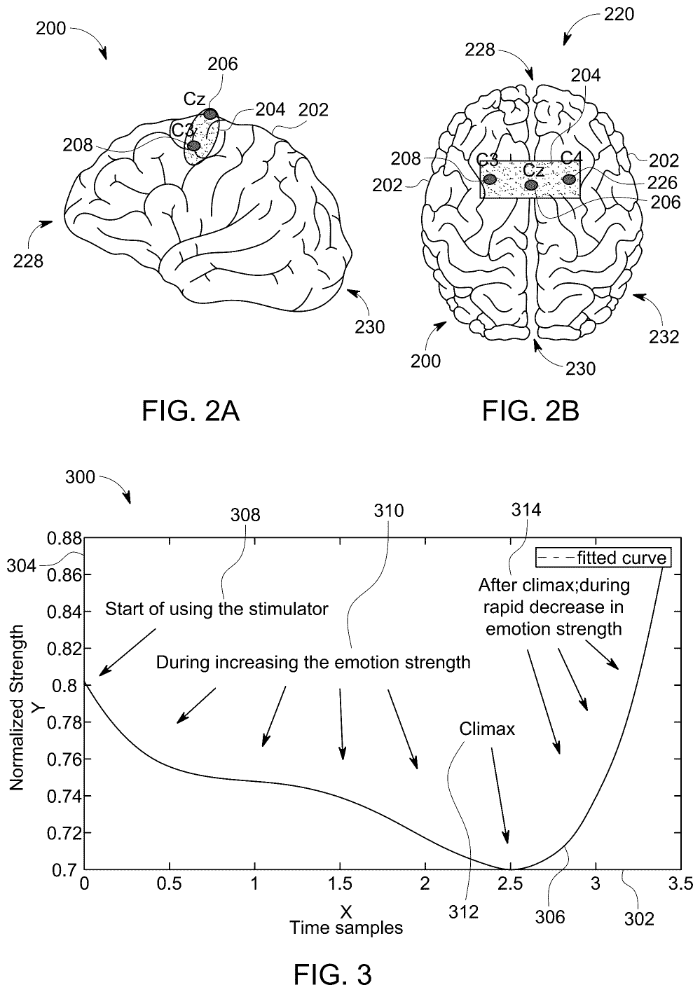

The present disclosure EEG system is a user-friendly wearable, including a single dry electrode positioned on the head central midline (namely Cz electrode location, but can vary around Cz—see FIGS. 2A and 2B) and an earlobe connection. FIGS. 2A and 2B outline a region on the brain (shown as a grey region in FIGS. 2A and 2B) where the related “wanting” EEG signal can be captured from any point of that. Three of the conventional EEG electrode setting positions fall within this region. This region accommodates C3, Cz, and C4 conventional (also called as 10-20 system of) EEG electrode locations. The earlobe connection is used as the ground pin (or the second input) of the EEG system (which is in fact a conventional low-noise differential amplifier). Although various parts in cortex, subcortex, and amygdala involve in the brain emotional processing, the above area has been found empirically to be the region where the emotion “wanting” can be best picked up non-invasively. This is more central for males and slightly lateral for females though the EEG system of this disclosure can capture the wanting signal within a good margin in the vicinity of Cz for both genders. The recording system needs low power, which is often supplied by using a rechargeable battery or a normal battery which can last up to 8 hours. As the system functions, it continuously records the EEG, digitizes it and transmits it to a smart cellular phone (or microcontroller) using Bluetooth.

The overarching concept behind the present disclosure is the discovery of a robust measurable metric for quantification of wanting level of sexual emotion, from the EEG signals (brain waves). This metric is low for more synchronization of the EEG signals, showing more “wanting” and high for less synchronization, showing otherwise. Traditional approaches to measuring the complexity of biological signals, by means of entropy or chaos estimation, fail to account for the multiple time scales inherent in the EEG signals (M. Costa, A. L. Goldberger, and C.-K. Peng, “Multiscale entropy analysis of biological signals,” DOI: 10.1103/PhysRevE.71.021906). On the other hand, nonuniform distributions of signal sample amplitudes make an entropy measure less descriptive of signal fluctuations. This limitation has been tackled by introducing dispersion entropy which distributes the samples into several classes (scale factor) based on their distributions (M. Rostaghi and H. Azami, “Dispersion Entropy: A measure for time series analysis,” 10.1109/LSP.2016.2542881). However, even by combining these two methods (H. Azami, E. Steven, E. Arnold, S. Sanei et al., “Multiscale Fluctuation-Based Dispersion Entropy and Its Applications to Neurological Diseases,” 10.1109/ACCESS.2019.2918560), and mitigating the effect of anomalies (out of range sample amplitudes) on the multiscale dispersion entropy (H. Azami, S. Sanei, and T. K. Rajji, “Ensemble entropy: A low bias approach for data analysis,” Doi. 10.1016/j.knosys.2022.109876) estimation, still the scale factor must be set empirically. In present disclosure, the scale is learned and estimated automatically (adaptively) for the best performance of the system.

In present disclosure the information captured by the EEG is the EEG signal amplitudes. Furthermore, the undesired components, such as eye-blinks, are detected, removed, and replaced by predicted EEG, and the dynamics of EEG (estimated by multiscale dispersion entropy process with particular level and scale) is respectively tracked, computed, smoothed and the trend towards sexual arousal is predicted continuously. The variation of this trend is decoded to run and control the driver motor in real time.

The processing of the information includes using the power of subspace-based prediction for single-channel signals in two phases, one to remove the eye-blink artefact (without access to any reference) and the other, is to predict the next state of the person's “wanting” state.

Briefly stated, the single-electrode EEG signal is processed in real time. The signal is filtered using a lowpass filter with a cut frequency of 35 Hz to remove national grid frequency 50/60 Hz and high frequency noise while maintaining the useful signal components. Then, the peaks related to eye-blinks are detected. These peaks occur randomly, and their average frequency of occurrence can vary from person to person. Then, a subspace technique is used to predict the signal and replace the peak with the predicted version. This completely removes large peaks (anomalies), mainly eye-blinks, from the EEG.

The process further detailed, in the pre-processing stage, the overlapping blocks (windows) of the EEG signal are denoised to minimize the effects of electrocardiogram (ECG), national grid frequency (50 Hz in the UK, and 60 Hz in the USA), system noise, the baseline, which causes non-zero average of the signal, eye-blinks, and eye movement which can appear frequently in EEG recordings. The noise and other anomaly signals are removed and the substantially denoised signals are normalized with respect to their variances (mainly to make the outcome subject-independent). To do this, for each segment the variance is calculated, and the signal is divided by the variance. The conventional methods for EEG artifact removal are applicable to multi-channel EEG and not to single-channel signals or time series. Here, an adaptive single channel source separation using subspace method is used to alleviate the noise and artifacts. A constrained singular spectrum analysis (SSA) is used for this purpose.

In the processing stage each signal block is processed, and a new multi-scale chaos evaluation is applied to assess the signal dynamics. The performance of the algorithm is dependent and adjusted on certain parameters' settings specifically for estimating the brain dynamics against sexual emotion and desire.

To enable robust (against anomalies in the waveform due to sudden changes in the user mood) and smooth change of the stimulator driver the values of above emotion metric in consecutive signal segments are interpolated (smoothed over consecutive windows or data segments, which slide with overlap over the signal) before being applied to the new-state predictor. A 5th order polynomial interpolator is found adequate and used for this purpose. Other alternative established methods such as autoregressive moving average method and recursive neural networks may also be applied; however, the former method (autoregressive moving average) is less accurate and latter method (recursive neural networks) is time consuming and it is difficult to realize (embed) it in hardware.

In the prediction stage, the next block of the smoothed signal is predicted. This is a crucial stage since the stimulator motor driver should accurately set to increase, decrease, or keep the current strength of stimulator driver. For this we apply SSA by empirically and accurately setting the SSA parameters including the embedding dimension and the length of prediction (i.e. the number of future signal samples to be forecasted—in our case this length is equal to the signal window size). As soon as the new block of signal is arrived and its dynamic level is estimated by means of adaptive multiscale dispersion entropy, the predicted values are replaced by the measured ones and the process continues. A sample of the estimated signal can be seen in FIG. 3. FIG. 3 is a graph representing normalized smoothed entropy of signal/variance strength versus time samples.

In the next block of the system in FIG. 1, i.e. slope estimation block, the dynamic signal slope is measured by signal differentiation (gradient) with respect to time, which shows how and by what extent the stimulator strength should change, i.e. increase, decrease, or remain as it is.

The output of slope estimator can be easily decoded into the necessary tunning (command) signal for the stimulator.

Depending on the type of stimulator, the driver signal can vary the strength (amplitude), frequency, vibration, or other movement-related parameters. Since the signals are normalized the driver signal varies within a limit and therefore, the stimulator movement is regularized and there will not be any hazard to the user.

It should be emphasized that unlike in EEG-based brain-computer interfacing (BCI) systems (which provides a pathway between the brain and external devices by interpreting EEG,) which benefit from some sorts of visual, audio, or haptic feedback, the feedback in the present disclosure solely depends on the changes in sexual emotion and level of wanting, which are estimated and evaluated to produce the command (tunning) stimulator signal. The initial stimulation (i.e. the instant stimulator touches the body) triggers and enhances the “wanting” emotional feeling. This “wanting” emotion demand is captured and used to increase the driver. This continues till the above feeling changes (for example, after reaching to a climax,) whereby the driver stops or slows down automatically.

The two main and primary applications of this invention are (1) controlling the stimulator level based on the person's “wanting” emotion demand, measurable from her/his brain waves, and (2) developing a so-called TeleSex controller, by using which, two partners can remotely deliver their sexual emotions to each other. The TeleSex controller requires two of the present disclosure systems. However, the driver can be embedded within or used by a wide range of stimulator types.

FIG. 1 shows an example of the overall block diagram of elements and process steps involved in the Emo-AI system. In various embodiments, the Emo-AI system 100 includes a headset 104 placed on a person's scalp 102. The headset 102 includes a single channel EEG electrode 106, an ear lobe electrode 108, and a combination battery and wireless transmitter assembly 110. The Emo-AI system 100 further includes an executable software 122, which is embedded in a mobile phone or microcontroller functioning as an electronic signal processing system. The executable software 122 which is embedded in an electronic signal processing system, where the electronic signal processing system includes a pre-processing stage 112, a processing stage 114, a new brain state prediction stage 116, a slope estimation stage 118, and a generating command signal stage identified as command stage 120. Emo-AI system 100 further includes a first signal path 124 transferring the EEG brain signal to the pre-processing stage 112, and a second signal path 126 transferring a command signal from the command stage 120 to a haptic caressing stimulator 128.

In various embodiments the headset 104 is the device that uses an EEG electrode 106 to sense electrical signals proximate to brain neurons including signal's voltage amplitude and signal's frequency, and variations in different statistical properties of the signals such as chaos or entropy. The headset 104 may be in the form of a hat (not shown) with multiple EEG electrode resting on a person's scalp 102, with electrodes in contacts with the person's scalp 102 at different locations on the scalp. Alternatively, as presented in present disclosure the headset 104 includes a single channel EEG electrode 106 resting on the person's scalp 102 electrically and physically coupled to the person's scalp at a single location to be detailed in FIGS. 2A and 2B infra.

The single channel EEG electrode 106 as part of the headset 104 includes multiple rounded pointed pins, or alternatively curled end pins, where the electrically conductive pins on the single channel EEG electrode 106 contact the person's scalp 102 providing an electrically and physically coupling to the scalp. The pins for such dry electrodes are standard rounded and smoothed at their tips so that while contacting the skin, they do not harm the person's scalp 102. In one embodiment the single channel electrode 106 has three or more pins to ensure when the headset 104 is positioned on the person's scalp 102 with hair there is an electrical and physical contact with the skin while the single channel EEG electrode 106 does not rock back and forth on the skin. Dry pin-type EEG electrodes, as compared to flat one, is to easily penetrate through the person's hair and rest on the scalp. In some situations where the person's scalp 102 at the contact area of the single channel EEG electrode 106 does not have protruding hair and the scalp contact area is bald, the electrically conductive contact section of the electrode may be a conductive planar or convex beveled surface instead of pins.

The earlobe electrode 108 as part of the EEG sensor is the second input of a differential amplifier which is electrically and physically coupled to the person's earlobe functioning, also used as an electrical ground. The earlobe electrode can also be mounted and make electrical and physical contact to any part of the person's scalp 102.

The electrical brain waves sensed by the headset's 104 single channel EEG electrode 106 is transferred to the wireless transmitter assembly 110, powered by a battery via the first signal path 124. The assembly 110 includes a battery, a differential amplifier, an analog to digital (A/D) converter, and a wireless Bluetooth transmitter. The battery which may be a rechargeable lithium battery or a normal battery, powers the electrical circuit including the single channel EEG electrode 106, the earlobe electrode 108 and the transmitter assembly 110.

The EEG signals are digitized before transmission. The sampling frequency is 100 Hz. This is to ensure that the EEG signals are received without any change and effect of environment noise or attenuation. There is no software-based change to the signals passing through the transmitter assembly 110. However, the EEG capturing system (which is mainly a differential amplifier) is designed in a way that it bypasses all the environment noises and amplifies the signals (both due to the nature of the differential amplifier). The remaining artifact to consider is the effect of eye-blinks.

The raw single-channel EEG signal is digitized using an A/D converter before being transmitted to an electronic signal processing system with the embedded executable software 122, through wireless communication over the first signal path 124. The short-range Bluetooth communication system ensures perfect data immunity from any noise during transmission mainly due to its digital transmission nature. The EEG electrode 106 in present disclosure is a pin-type (rather than flat-often used for forehead skin contact) dry electrode to enable the recording from Cz position over the head (often covered by hair). The electronic signal processing system with embedded executable software 122 in the present disclosure is part of a mobile telephone. The executable software 122 may alternatively be embedded on a microcontroller functioning as the electronic signal processing system.

The wirelessly transmitted EEG signal then goes through a pre-processing stage 112. During the pre-processing stage 112, the digitalized EEG signals are lowpass filtered (using Butterworth filter of order 11) between 1 Hz to 35 Hz and the DC (average) is removed. This removes noise and the effect of supply grid frequency (50/60 Hz). Then, eye-blinks are detected and replaced by prediction of the signal from the samples prior to the eye-blink. This is done by the singular spectrum analysis (SSA)-based prediction of the eye-blink duration from the (0.1 sec) samples before that. In an EEG signal pattern, an eye-blink manifests itself as a significant departure from the original continuous limited signal amplitude fluctuation in the form of a sharp peak (jump in amplitude) over a short duration of 10-40 msec, where the EEG signal goes back to normal signal amplitude fluctuation after the eye-blink. The eye-blink EEG signal caused amplitude fluctuation is very short in duration and may be five to ten times the normal signal (peak) amplitude fluctuation. The eye-blink caused fluctuation is automatically replaced (from 0.1 sec before to 0.3 sec after its main peak) by a predicted sequence of normal amplitude fluctuations. The prediction process uses a SSA-based prediction method.

SSA-based prediction has three main stages of Decomposition, Grouping, and Reconstruction. In the present disclosure application, where only one EEG electrode is used as a single channel EEG signal reader, in the reconstruction stage the first six eigentriples (combination of eigenvalues and eigenvectors) are used for prediction. This number is empirical and selected to make a compromise between best following the signal fluctuation and having best noise removal. The detection of the eye-blink EEG signal reading 608 in present disclosure is accomplished without access to any reference (such as electrooculogram or eye movement tracker) and is merely done by analyzing the original EEG signal readings to detect the blink, remove it, and replace it with the predicted EEG. Following this approach, any other abnormal abruption of the signal can be restored.

The digitized EEG signal with the eye-blink fluctuations removed, then is processed through the processing stage 114. At the processing stage 114 the signal is received continuously (real-time) and is processed in segments of 2 (can be up to 3) seconds. The signal dynamics recorded from the Cz region on the scalp is computed through adaptive multiscale dispersion entropy estimation. In this process, the anomaly samples, if any, are rejected and the entropy is estimated by automatically selecting a certain scale. The selected scale caters for best discriminating between various brain states. The resulting digitized EEG signal is denoised at this point and does not include any environmental effect such as 50 or 60 Hz general alternative current power line (grid) frequency effects, eye-blink signal, electrocardiogram, or other undesired interferences or anomalies.

The denoised EEG signal samples next enter the phase of new brain state prediction stage 116. Since the signals are processed segment by segment, the haptic caressing stimulator 128 should get input as to what to do next. Therefore, after the entropy estimates are smoothed using a degree polynomial (See FIG. 3), the signal trend is predicted using SSA. Trend is referred to a signal reconstructed by using only the first eigentriple of the covariance matrix. So, the SSA-based prediction process is similar to the prediction process used for replacing eye-blink fluctuation with a predicted normal EEG signal fluctuation, but only one (the first) eigentriple is used for reconstruction/prediction. This will guide the haptic caressing stimulator 128 in how to behave in the next 2 (or 3) seconds. As soon as the new segment of the smoothed EEG signal is received, it replaces the previously predicted one, and the new accurate segment is used to predict the next segment and so on.

The processed EEG signal next enters the slope estimation stage 118. At this stage the signal segments (of 2 sec each) are already smoothed and differentiable. The slope at each sample is referred to as differentiation in discrete domain at that sample. In the sample domain, differentiation means the difference between the consecutive samples. The difference can be negative or positive relating to increase or decrease in the stimulator driver power. On the other hand, the value of this differentiation corresponds to how faster or slower this increase or decrease in power should take place. This is to capture if the user wants more (increase the power of) or less (decrease the power of) stimulation of the haptic caressing stimulation 128.

Next at the generating command signal stage 120 given that the generated output is digital, it is safely (and wirelessly) transmitted 126 to a receiver (not shown,) which is equipped with a wireless Bluetooth receiver. The received digital signal is then converted to analogue by means of a D/A and applied to a direct current (DC) motor. Depending on the user preference the DC motor control signal is converted to a suitable type of haptic movement using proper gears coupling the motor axel/shaft to the haptic caressing stimulator 128, i.e., vibrating, rotation, thrusting, or other motions. There are many haptic caressing stimulator 128 types in the market with various capabilities, which are not the subject of present disclosure. Instead, the Emo-AI system 100 of present disclosure delivers the command signal safely to the DC motor. A direct current motor assembly will be referred to as a DC motor with wireless receiver for receiving the command signals.

The command signal is the tuning signal transmitted 126 to the haptic caressing stimulator 128 and is based on the processed brain wave EEG signal sensed from the user brain detecting and tracking the user's real-time brain sexual wanting state and predicting the very near future upcoming level of the brain wanting state, commanding the haptic caressing stimulator 128 to actuate further stimulation to enhance the user's sexual arousing wanting feeling, or reduce the stimulation when the person has reached a sexual climax or their wanting feeling decreased.

FIG. 2A shows an example of human brain lateral view configuration identifying the frontal scalp region proximities for EEG electrode setting positions. In various embodiments, the brain left lateral view 200 shows a surface of the brain 202, with potential recording zone highlighted in grey 204. From any point of this grey region 204 the related “wanting” EEG signal is captured. Cz 206 and its neighboring electrode C3 208 can capture the information about wanting state of the brain. The electrode names C3 and Cz follow the conventional EEG 10-20 electrode positioning system.

FIG. 2B shows an example of human brain top view configuration identifying frontal region proximities for EEG electrode setting positions. In various embodiments, the brain top view 220 shows both the left 200 and right 232 brain lobes, and the brain surface 202, highlighted in grey 204 form the region where the related “wanting” EEG signal is captured. Three of the conventional EEG electrode setting positions C3 208, Cz 206, and C4 226 fall within this gray region 204. The locations of C3 208, Cz 208, and C4 226 follow the conventional 10-20 EEG electrode positioning system. C3, Cz, and C4 refer to left lateral, mid central, and right lateral scalp positions and are used to capture the brain wanting state together with brain motor activity if any.

FIG. 3 shows an example of a sample of the processor output signal which is (inverted and) transmitted in real-time to a haptic diver. In various embodiments, the graph 300 shows a fitted curve 306 depicting y axis 304 showing measures of a normalized strength of EEG signal versus x axis 302 showing the time samples, starting from initiation of EEG reading at time zero advancing towards the time at the end of EEG reading time. This duration corresponds to the time from start of using the stimulator 308, followed by the section of the fitted curve 306 depicting the EEG normalized strength 304 values and the duration where the wanting emotion strength 310 of the user is gradually increased, to a maximum strength, which can be climax 312, and finally the time where the wanting level is decreased. The fitted entropy curve 306 continues to the end of EEG signal reading of the user. The smoothed entropy curve clearly shows the cycle of increasing in wanting, reaching to climax, and rapidly losing interest after that 314.

The graph 300 shows the EEG brain wave reading normal EEG 304 of the user during a period of time from start of using the stimulator 308 corresponding to the initial enjoyment desire, followed by the state of enhancing the wanting strength, when the user goes through an increase of sexual desire 310, then, the moment the user reaches sexual climax 312, and to the point after climax when a rapid decrease in sexual desire 314 indicates the end of the user sexual arousal and enjoyment journey. The fitted curve 306 shows different levels of user normalized strength 304 the entropy information extracted from the EEG representing the level of user sexual arousal and enjoyment as the time 302 passes. The graph 300 shows the fitted curve 306 is a sample normalized entropy 304 of the EEG brain wave readings at each stage. Generally, this curve is different for each user and the timing 302 of reaching each of the emotion strengths is also different for each user. This follows the fact that for each user various levels of sexual desire including initial strength 308 EEG, the normalized strength at climax 312 EEG, and the normalized entropy at the final/calm state are different. Some users go through a relatively large difference between the EEG reading at the initial arousal stage measured by the reading at the start of using the stimulator 308 compared to the EEG reading at the climax 312 stage, whereas others experience a smaller difference between the EEG reading at the start of arousal measured at the start of using the stimulator 308 compared to the climax 312 EEG reading. Accordingly, the actual time 302 duration of the user sexual arousal and enjoyment journey is also different between users from the start of using the stimulator 308 to the point of climax, and during rapid decrease of user emotion strength 314 when the user ends the sexual enjoyment journey. Furthermore, different users have different durations between each stage through their sexual enjoyment journey.

Because of these variation of sexual emotion strengths and the time, for each individual it takes different patterns and durations of their brain wanting states along this sexual stimulation process. This means that there is neither similar (universal) highest and lowest strengths in sexual emotion nor any corresponding known fixed period between stages of sexual emotion strength. The present disclosure discloses a system that uses signal processing and artificial intelligence to predict the user's next level of sexual emotion strength EEG brain wave reading without using a feedback system (often utilized for training that system) and commands the haptic caressing stimulator used by the user to increase or reduce the haptic activity of the stimulator to further enhance the user's sexual enjoyment without direct physical input by the user or any physical (audio, visual, or haptic) feedback, allowing the user to more conveniently enjoy the sexual enjoyment journey with no concern for manually controlling (or learning how to control) the level of activity of the haptic sexual stimulator.

FIG. 4 shows an example of a lateral view of a human brain identifying areas responsible for, and the path of, signals specific to “wanting” and “liking”. In various embodiments, the brain 400 includes a brain cortex 402, location of dopamine generators 404, a brainstem 406, amygdala 408, ventral pallidum 410, end of the neuron path for the liking emotion 412, nucleus accumbens 414, prefrontal cortex 416, the pathway for emotion wanting component 418, striatum 420, and the neuron path for the emotion liking component 422.

Following is a brief explanation of the above identified sections in the brain 400. Brain dopamine generators 404 release dopamine which is a compound present in the body and brain as a neurotransmitter and a precursor of other substances including epinephrine. Lack of dopamine causes serious neurological diseases such as Parkinson's. Amygdala 408 is a region of the brain primarily associated with emotional processes. The amygdala 408 is located in the medial temporal lobe, just anterior to (in front) of the hippocampus (not shown). Nucleus Accumbens 414 is the neural interface between motivation and action, and plays a key role on feeding, sexual rewards, stress-, drug self-administration behaviors. Neurons projecting to the nucleus accumbens 414 activate it and result in an increase in the dopamine level in the nucleus accumbens 414. The nucleus accumbens 414 is an important component of a major dopaminergic pathway in the brain called the mesolimbic pathway, which is stimulated during rewarding experiences. Prefrontal cortex 416 is the personality center of the brain. Prefrontal cortex 416 is where a person processes moment-to-moment input from the surroundings, compares the input to past experiences, and then reacts to them. Prefrontal cortex 416 is one of the last places in the brain to mature and is fully developed at about 25 years of age. Prefrontal cortex 416 governs the management of emotions and motivations by the limbic system in an adolescent brain. Striatum 420 is a cluster of interconnected nuclei and the largest structure of the basal ganglia. Striatum 420 is involved in decision making functions, including motor control, emotion, habit formation, and reward.

To better describe the relation and common aspects of “liking” and “wanting” emotions in the brain, where for example addiction is a part of wanting emotion, in reference to FIG. 4 showing an example of a lateral view of a human brain identifying areas responsible for, and the path of, signals specific to “wanting” and “liking”, the following explanation is descriptive:

‘Wanting’ is mediated by a robust brain system including dopamine 404 projection, whereas ‘liking’ is mediated by a restricted brain system of small hedonic hotspots, including brain stem 406, ventral pallidum 410, end of the neuronal path for the liking emotion 412, and nucleus accumbens 414 (as described in Berridge & Kringelbach, 2015). The incentive-sensitization theory of addiction (shown in FIG. 5 infra) shows how ‘wanting’ may grow over time independently of ‘liking’ as an individual becomes an addict, due to sensitization of brain mesolimbic systems. (FIG. 5 shown in present disclosure is a reproduction of a figure that was adapted by Shannon Cole and Daniel Castro from Robinson & Berridge, 1993).

In distinguishing between reward ‘wanting’ from reward ‘liking’, it is believed that dopamine 404 generated in the brain mediates sensory pleasure, however research has indicated that dopamine 404 mediates only a form of ‘wanting’ for reward called incentive salience, and not pleasure ‘liking’. To better understand the psychological nature of incentive salience and to clarify its brain mesolimbic mechanisms.

FIG. 5 shows an example of a diagram showcasing the relative effects of wanting versus liking over time. In various embodiments, the graph 500 shows the relative effect 504 of using an item over time 502 in study of addiction 516 aspects in brain, Where, starting from an initial use 518 time, a horizontal relative effect line shows a steady state interest 512 level of relative effect showing no increased sense of interest in user. An intense increased interest in use towards addiction 516 is reflected by either the straight upward incline line 508 showing a steady state increase in interest toward end of use in addiction 516 as a wanting emotion 514, or an altering slope upward relative effect 504 interest in use depicted by the altering slope upward line 510 showing an initial lower rising interest in the drug use, which due to the continued drug use becomes an accelerated interest in the drug use leading to addiction 516 as a wanting emotion 514. Alternatively, if the continuation of drug use does not result in any strong appetite for further use, the relative effect 504 represented as a downward slope line 506 is an indication of liking emotion 520.

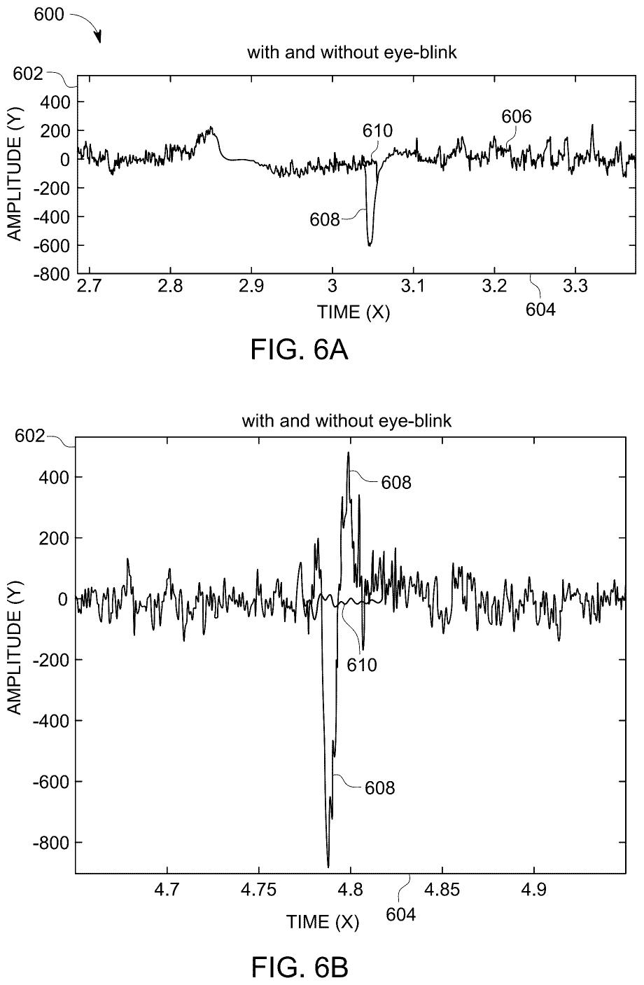

FIGS. 6A and 6B show two examples of a user brain wave EEG signal reading with eye-blink and after eye-blink removed through processing and prediction. In various embodiments, the graph 600 shows an example of brain wave EEG signal reading 606, where a x-axis 604 of the graph shows a sample of time duration versus a y axis 602 showing the amplitude a sample of EEG signal reading 606. A section of the EEG signal reading 606 includes the effect of an eye-blink EEG signal reading 608, and its replacement by a predicted EEG signal 610. The eye-blink is an interfering signal 608 superimposed to the substantially consistent course of EEG signal reading 606.

The EEG signal reading 606 are lowpass filtered (using Butterworth filter of order 11) between 1 Hz to 35 Hz and the DC (average) is removed. This removes noise and the effect of supply grid frequency (50/60 Hz). Then, the eye-blink interferences 608 are detected and replaced by the prediction of EEG signal reading 610. This is done by the singular spectrum analysis (SSA)-based prediction of the EEG signal from 0.1 sec prior to the eye-blink. FIGS. 6A and 6B show two examples where the eye-blink interference 608 (part of original EEG signal reading 606) is automatically replaced (from 0.1 sec before the eye-blink peak value to 0.3 sec after that) by the predicted EEG signal reading 610.

From both FIGS. 6A and 6B it is shown that the signal details have been captured by the prediction method. The prediction process for replacing the eye-blink EEG signal reading 608 where the single channel EEG signal reader uses only one EEG electrode as in present disclosure uses SSA-based prediction. SSA-based prediction has three main stages of Decomposition, Grouping, and Reconstruction. In this application, where present disclosure uses only one EEG electrode as a single channel EEG signal reader, in the reconstruction stage the first six eigentriples are used for prediction. Selection of the number of eigentriples is empirical and makes a compromise between best following the signal fluctuation and having best noise removal. The detection of the eye-blink interference from the EEG signal 608 in present disclosure is accomplished without access to any reference, and is done by analyzing the original EEG signal reading 606, detecting the eye-blink 608 as an anomaly in the EEG signal.

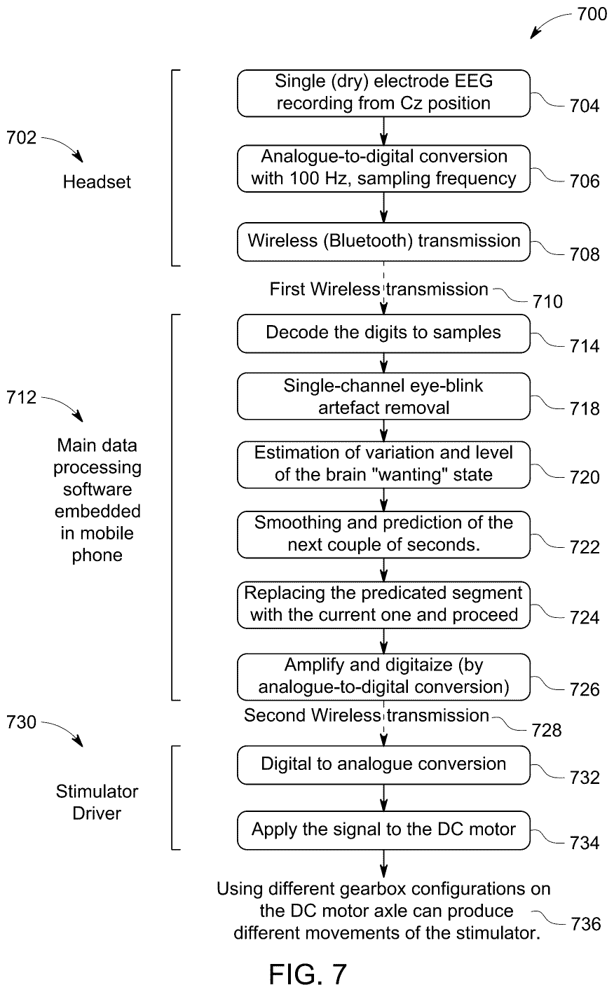

FIG. 7 shows an example of a flow diagram providing a general outline of steps included in an algorithm used to process EEG brain signals to actuate a haptic caressing stimulator. In various embodiments, the algorithm 700 details the steps used by the Emotion AI (Emo-AI) to transform a user's EEG brain signal readings into commands for actuating a haptic caressing sexual stimulator to enhance the user's sexual enjoyment. Algorithm 700 includes three main sets of processes, the first main set relating to a headset 702, the second main set relating to the processing software 712 covering the main data processing software embedded in a mobile phone (which can also be in a microcontroller), and the third main set relating to a stimulator driver 730.

As a subset of first set of processes under headset 702, step 704 includes a single (dry) EEG electrode recording from Cz position on the user's scalp; step 706 includes analogue to digital conversion of the EEG readings with 100 Hz sampling frequency; and step 708 includes wireless (Bluetooth) transmission of the EEG readings after preliminary signal processing steps to a processor in a mobile phone or a microcontroller for further signal processing. This first wireless transmission 710 is a step connecting the first and second sets of processes.

As a subset of second set of processes under processing software 712 covering main data processing software embedded in a mobile phone, step 714 includes decoding the EEG signal reading digits to samples; Step 718 includes removing single channel eye-blink artefact from the EEG signal readings; step 720 includes estimation of variation and level of the user's brain “wanting” state; step 722 includes smoothing of the EEG signal readings and prediction of the next couple of seconds of EEG signal readings; step 724 includes replacing the predicted segment with the current one and proceeding with the signal processing; step 726 includes amplifying and digitizing the signal using an analogue to digital conversion; next step is the second wireless transmission 728 of the digital signals to a stimulator.

As a subset of third main set of processes under stimulator 730, step 732 includes converting the processed digital signals to analogue; step 734 includes applying the analogue processed signal as a command to a DC (direct current) motor, which acts as an actuator; and step 736 includes using different gear box configurations on the DC motor axel producing different movements of the stimulator, which is a haptic caressing stimulator which may have one or more movements including vibration, rotation, trusting, or a combination of these movements.

The algorithm 700 includes three general main sets. The first main set at the top of algorithm 700 is the headset 702. In the first set, headset 702, a raw EEG data is captured using 100 samples per second. In general, the available commercial off the shelf EEG systems use multiple flat electrode (not shown) to record brain signal waves from the user's forehead, these general use EEG systems are usually made for computer gaming purposes and often have a sample reading of 250 Hz to 500 Hz.

In present disclosure two changes are made to the general-purpose EEG system. The first change is lowering the sampling frequency to 100 Hz. This lower sample rate will affect the required speed of algorithm and enables longer use of the battery in the headset. The second change is use of a single EEG electrode coupled to a Cz section of the user scalp. The single electrode has one or more coupling pins (not shown) with tip-rounded or curved pins that are not sharp and are convenient to use yet maintaining the necessary electrical contact with the scalp even by long-hair users.

The second main set of processing software 712 is in the middle stage of the system which was initially developed using MATLAB software, later was converted to a low-level software language to be usable by a mobile phone. At this point the digital signal is converted back from digits to sample amplitudes. In the steps of the second stage (middle stage in FIG. 1), for the first time the dynamics/changes of the brain “wanting state” is estimated in real-time. The signals at this stage are different from those representing the emotion state and can be used to estimate and predict the brain response to evolution/enhancement/decrease of human desire (which can be different from emotion).

Each estimation-of-wanting series of consecutive EEG signal readings (or a block of estimation-of-wanting) is followed by a prediction of the next block of wanting signal. This is used to control the stimulator driver. As soon as the next block of wanting state is received, the predicted block is replaced with the actual estimate of wanting, and the system proceeds to prediction of the next wanting signal segment. This cycle of estimating the new/next block of the wanting signal and replacing it with the actual block, enables provision of a smooth driver control signal and better synchronization between the changes in the emotion wanting level and the stimulator movement, thus enabling real-time application of the system. For a robust continuous set of signals and to mitigate the anomalies, the estimates are smoothed, and the prediction is performed on the smoothed estimates. The data is then converted to digital again to enable noise-free Bluetooth communication with the stimulator driver.

As a comparison between present disclosure and existing EEG systems used for gaming industries, where the gaming EEG systems rely on brain EEG reading feedback, the following description provides some clarification. Feedback (visual, audio, or haptic) is used in BCI or gaming systems for learning or training the system. This means a response is produced in the brain due to the feedback. In such systems, the response is elicited in the form of an event-related response (ERP) and produced as the response to each feedback separately. This system of strong feedback uses frequent/non-target stimuli for gaming systems or infrequent/target stimuli for most of BCI applications. However, such feedback requires time to learn each stage of a movement and certainly is neither suitable nor relevant to our present disclosure system. In present disclosure system the EEG system senses the level of brain demand and satisfaction (not by learning) and acts accordingly. Conceptually, a person involved in brain-computer interfacing using EEG may conclude that there might be some similarities between the two approaches, but technically and physically they are different. The feedback approach used in gaming systems is through learning by the brain via continuous visual feedback, whereas the system used in present disclosure is via sensing the state of the sexual wanting emotion in the brain through direct EEG signal readings by the system.

Two main elements of the signal processing of the present disclosure consist of first element including effective and very accurate (with an accuracy of >90%) removal of eye-blinks while using a single channel EEG signal reading headset and replacing eye-blink anomaly signal with a prediction of EEGs with no eye-blink. This is significant, because with a multichannel EEG signals it would be simpler and easier to remove an eye-blink signal anomaly by means of multi-channel processing techniques such as independent component analysis (ICA). ICA requires the number of signal sources to be less or equal to the number of electrodes. However, in present disclosure the available signals are from a single channel EEG electrode, which obviously does not fulfill the ICA (or similar algorithms') condition. Detection of the anomaly and predicting a replacement set of signals require more sophisticated statistical analyses and signal processing. The following description elaborates on the differences between sensing and eliminating eye-blink signals using a single channel versus a multi-channel EEG reading electrode system.

For multi-channel EEG recordings and based on the concept of ICA, if N independent sources are linearly mixed into M mixtures where M>=N (where M is larger or equal to N), an unmixing matrix can be estimated. By multiplying this matrix by the matrix of signal mixtures, the independent original signal sources are recovered. This is mainly by exploiting the “independency” of the sources (here eye-blink is independent of the EEG sources) in estimating the unmixing (or separating) matrix. Of course, there are also issues with using ICA for multichannel source separation; of the most well-known ones are ambiguities in permutation (order) of the sources and scaling the estimated signals.

If the number of sources is more than the number of sensors (mixtures or EEG electrodes), then ICA does not work unless some constraints such as sparsity of the sources can be imposed into the formulation (such as in Li's Algorithm or DUET algorithm produced by Scott Rickard, both work when at least two-channels are available).

In present disclosure case we are down into only a single measurement. Therefore, we cannot use a regular method to directly separate the eye-blinks. So, we detect the peaks, which are more likely to be the eye-blinks, remove them, and replace the samples with the predicted EEG signal. Since eye-blink is an independent (from the EEG) source, this method works for detecting and removing eye-blinks in a single electrode EEG reading system used in present disclosure.

Second main element is estimation of the brain dynamical changes due to the “wanting” level variation for the first time using an adaptive multiscale dispersion entropy. The adaptivity refers to (a) selection of a suitable scale for the algorithm through learning, and (b) avoiding anomalies and artefacts in the estimation. The following description further elaborates on the adaptive multiscale dispersion entropy.

Since the brain waves (EEGs) are inherently noisy, the conventional chaos or entropy measures do not work for effectively measuring the brain dynamics or desynchronization (entropy) level. Multiscale dispersion entropy allows for measuring such desynchronization (entropy) in different amplitude ranges to marginalize the inherent noise. The scale can be defined, and, in many applications, different scales (from 1 to 20 or more) are tested and the best reported and used. Moreover, any anomaly such as spikes in EEG can distort the results. In present disclosure system, the scale is initiated and then automatically estimated in the first few (3-5) seconds of recording by exploiting the maximum difference between the entropy levels of adjacent data segments. Also, the adjacent entropy levels are exploited to enhance the robustness against anomalies.

The second main set of steps (middle stage of algorithm) processing software 712 of the mobile phone communicates with the third main set of steps stimulator 730 (last stage of the algorithm located at the bottom of the algorithm 700) continuously. The processed data is amplified and digitized (by analog to digital conversion) 726 in second main stage 712 of the algorithm, and wirelessly transmitted 723 to the stimulator 730 (third main stage of the algorithm). The processed signal is then changed to analogue 732 before being applied to the DC motor 734, which is coupled to a caressing haptic stimulator. The choice of DC motor instead of stepper motor in present disclosure is mainly due to the DC motor's smaller size and ease of use.

Conventional gearboxes are coupled to the DC motor axle 736 to allow for various movements such as thrusting, rotation, vibration, or a combination of the movements by the caressing haptic stimulator.

It is understood that unless explicitly stated or specified, the steps described in a process are not ordered and may not necessarily be performed or occurred in the order described or depicted. For example, step A in a process described prior to step B in the same process, may be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in the text, the claimed invention can be practiced in many ways. The system may vary considerably in its implementation details, while still being encompassed by the claimed invention disclosed herein.

Any particular terminology used when describing certain features or aspects of the disclosure should not imply that the terminology is being redefined herein. This ensures that any specific characteristic, feature, or aspect of the disclosure is restricted to which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It is understood that by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It is further understood that by those within the art that if a specific number of introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles to introduce claim recitations. In addition, even if a specific number of introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It is further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” is understood to include the possibilities of “A” or “B” or “A and B.” It is further understood that any phrase of the form “A/B” shall mean any one of “A”, “B”, “A or B”, or “A and B”. This construction includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments but is intended to cover various arrangements included within the spirit and scope of the broadest interpretation so as to encompass all such modifications and equivalent arrangements.

What is claimed is:

1. A system, comprising:
a headset with a single dry pin-type electrode for recording the electroencephalography (EEG) signals, an earlobe ground connector, and a primary signal preprocessing unit;
a multi-stage signal processing software embedded on a smart phone;
a direct current motor driver assembly accepting commanding signals, the commanding signals wirelessly transmitted from the smart phone;
the direct current motor coupled to a gearset, where the gearset is further coupled to a haptic caressing stimulator; and
the haptic caressing stimulator coupled to a user's sexually sensitive erogenous body part.

2. The primary signal processing unit of claim 1, further including a lowpass filter, a battery, an amplifier, an analogue to digital signal convertor, and a Bluetooth transmitter.

3. Single electrode of claim 1, further consisting of a single dry electrode with a plurality of pins with rounded-tip or curved pins, electrically coupled to a user scalp around a mid-central, Cz, zone of the scalp.

4. A method, comprising:
Varying, enhancing or reducing, a body stimulation by measuring a user sexual wanting emotion, using a single electrode brain wave signal reading EEG system;
reading the user brain waves indicating sexual wanting emotion from a user's scalp within region Cz;
denoising the signal readings;
replacing an eye-blink anomaly in EEG signals with real-time predicted EEG signals;
using an existing EEG entropy to predict a next 2 to 3 seconds of smoothed signal entropy;
using the predicted block of smoothed EEG entropy signal as continuation of control signal;
replacing the predicted block of control signal with the next predicted smoothed EEG entropy;
providing a continuous control signal as the smoothed approximation of the EEG entropy;
using the continuous set of brain signals, sensing a user sexual wanting emotion in real-time, and predicting an upcoming sexual wanting emotion, generating a set of commands to actuate a direct current motor coupled to a gearset, further coupled to a haptic caressing stimulator causing a vibration, rotation, and/or thrusting motion of the haptic caressing stimulator coupled to a user's sexually sensitive erogenous body part; and
varying the controller strength by following the changes in the user's sexual wanting emotion.

5. The method of claim 4, wherein the EEG system further comprising a headset including a single dry electrode;
the electrode comprising a plurality of pins with rounded-tip or curved pins; and
the electrode pins electrically coupled to the user's scalp about the Cz region.

6. The headset of claim 5, further comprising a preliminary signal processing system including an amplifier, an A/D convertor, a lowpass filter, and a wireless signal transmitter;
wherein a preprocessing stage performed by the preliminary signal processing includes denoising the EEG signal reading using a lowpass filter to remove the national grid of 50 Hz or 60 Hz interference; enhancing EEG signal amplitude using the amplifier, converting the analogue signal to digital signals using the A/D convertor; and
wirelessly transmitting the preliminary processed signals to a smart phone with a signal processing software embedded in the smart phone.

7. The signal processing software of claim 6, further replacing eye-blink caused anomaly in the EEG signal readings, including detecting the eye-blink caused signals, sensed using the single dry electrode, by singular spectrum analysis; and
wherein analyzing eye-blink peaks of signals includes peak detection, removing an interval starting from 0.1 seconds before the peak to 0.3 seconds after the peak, and replacing this interval with a prediction of EEG from prior to that.

8. The signal processing software of claim 6, using an estimated smoothed entropy block-by-block and predicting a next block of a smoothed control signal.

9. The signal processing software of claim 8, wherein the EEG brain wave signal reading, representing the user's sexual wanting emotion as a follow-on to the real-time EEG reading;
controlling the motor driver continuously by capturing and processing the EEG signal;
enabling continuous motor control by one-step ahead prediction of the control signal;
at each time instant, transmitting the most recent control signal to the motor driver wirelessly for actuating the haptic caressing stimulator;
the continuous prediction of next block of EEG signals comprising singular spectrum analysis (SSA) based prediction 2 to 3 seconds of the control signal trend and evaluating the slope of a smoother entropy curve; and
using the slope estimation of increasing or reducing sexual wanting emotions in commanding the haptic caressing stimulator to increase or reduce its movement.

10. A combined Signal Processing and Artificial Intelligence system, comprising:
a single dry electrode EEG brain wave reader;
reading sexual wanting emotion signals from a user's scalp Cz region;
denoising the signals, and replacing eye-blink anomaly signals from the EEG signal readings with predicted version of the EEG signal samples using singular spectrum analysis (SSA);
predicting a 2 to 3 seconds follow-on block of control signals, estimated using adaptive multiscale dispersion entropy;
wherein an entropy is continuously estimated from the ongoing EEG signals and smoothed;
wherein the predicted block is iteratively replaced with the new smoothed entropy estimate and used for smooth controlling a stimulator driver;
wherein estimations are performed block-by-block without learning through any feedback;
generating a set of command signals transmitted to a direct current motor based on predicted user's sexual wanting emotion signals;
the direct current motor actuating a haptic caressing stimulator coupled to the user erogenous body part, actuating the haptic caressing stimulator to provide vibration, rotation, and/or thrusting motion in a reducing or increasing amplitude; and
varying the control signal as the response to the level of user's sexual wanting emotion.

11. The EEG signal denoising of claim 10, including using electronic lowpass filter to eliminate grid frequency of 50 Hz or 60 Hz caused EEG signal reading noise;
amplifying the signals using amplifier;
converting the analogue EEG signal readings to digital signals using an analogue to digital convertor; and
wirelessly transmitting the resulting digital signal to a smart phone with an embedded data processing software or a micro controller for processing the signals.

12. The replacing eye-blink signals of claim 10, including detecting and removal of the eye-blink signals read using the single dry EEG electrode by applying a cascade of peak detection and SSA-based prediction;
wherein analyzing peaks of signals includes estimation of the recorded EEG signals in the first 3 to 5 seconds of EEG recording, and detecting the peaks by comparing their amplitude with an approximately two and a half times multiple of signal variance;
predicting the replacement of the signals using a singular spectrum analysis (SSA) based prediction for a duration of about 0.1 seconds before to 0.3 seconds after the main peak of the eye-blink by a predicted sequence of EEG normal amplitude fluctuations; and
replacing the eye-blink signal anomaly with the prediction of EEG signals with no eye-blink effect.

13. The predicting of the 2 to 3 seconds follow-on block of signals to the real-time EEG signal readings of claim 10, including predicting a next block of EEG brain wave signal reading, representing the user's sexual wanting emotion as a follow-on to the real-time EEG reading;
the predicting of EEG signals, using the latest real-time EEG signal readings without using any feedback from the user physical reactions;
wherein the predicted signals are added to the end of real-time EEG signal reading, further being replaced by continuing real-time EEG reading to be used for the next block of predicted signals, providing a continuous evaluation of the sexual wanting emotion from the EEG signals;
the continuous prediction of next block of EEG signals comprising calculation of a slope of sexual wanting emotion trend and estimating how much and with what rate the wanting state of the brain changes;
where the slope estimation is done by using only a first eigentriple of a covariance matrix of EEG signals for prediction of a next block of signals; and
using the slope estimation of increasing or reducing sexual wanting emotions in commanding the haptic caressing stimulator to increase or reduce its movement both in shorter or longer time.

14. The generating of the set of command signals of claim 10, including amplifying and conversion of the latest predicted block of signals representing the predicted sexual wanting emotions of the user from digital signals to analogue signals; and
translating the latest predicted block of signals representing the predicted sexual wanting emotions of the user to command signals suitable for activating the direct current motor by transmitting the command signals to the direct current motor.

15. The direct current motor actuating the haptic caressing stimulator of claim 10, including the receipt of command signals by the direct current motor assembly;
the direct current motor coupled to a gearset, where the gearset is further coupled to the haptic caressing stimulator; and
the command signals received by the direct current motor assembly actuating the direct current motor and in turn causing haptic caressing stimulator motions including vibration, rotation and/or thrusting, in a declining or increasing amplitude.

16. The direct current motor actuating the haptic caressing stimulator of claim 10, including the haptic caressing stimulator being coupled to the user's erogenous body part;
the haptic caressing stimulator providing vibration, rotation, and/or thrusting motions, with appropriate increasing or decreasing amplitude with a rate corresponding to the slope of the smoothed predicted brain wanting state, based on user's increasing or reducing sexual wanting emotion; and
using the haptic caressing stimulator for enhancing sexual pleasure.
